(19) United States
(12) Patent Application Publication
(10) Pub. No.: US 2014/0091083 A1
(43) Pub. Date: Apr. 3, 2014

(54) INDUCTION HEATING DEVICE FOR HEATING A LIQUID

(71) Applicant: Connie McGarvey, Bunbeg (IE)

(72) Inventor: Connie McGarvey, Bunbeg (IE)

(21) Appl. No.: 14/123,606

(22) PCT Filed: Jun. 13, 2012
(86) PCT No.: PCT/EP2012/002486

§ 371 Date: Dec. 3, 2013

(30) Foreign Application Priority Data
Jun. 14, 2011 (GB) 1109909.0

(51) Int. Cl. H05B 6/36

(52) U.S. Cl. CPC H05B 6/36
USPC 219/634

(57) ABSTRACT

An induction heating device for heating a liquid, said device comprising a half ellipsoidal shaped induction coil and matching susceptor.

This invention relates to an induction heating device for heating a liquid, in particular for heating a liquid in a vessel, such as a bottle for infant formula or a lid therefor or a kettle for heating water.

Induction heating is a non-contact heating process wherein heat is generated in an electrically conducting ferrous object by electromagnetic induction, said object being located within or adjacent a coil whereby eddy currents are generated within the object by electromagnetic radiation generated by the coil, leading to heating of the object. Said object typically comprises a metallic susceptor arranged to be in thermal contact with an item or fluid to be heated.

The use of induction heating to heat water and for heating a cooking hob is very well known. Such known heating devices invariably use planar coils placed below a flat plate susceptor upon which an object to be heated is placed. GB 2,445,780 is an example of a kettle using an induction heater having a planar coil.

Induction hobs are praised for their energy efficiency compared to conventional electric and gas hobs. The efficiency of energy transfer for a typical induction hob is around 89% compared to 71% for an electric hob and around 49% for a gas hob. Another benefit induction hobs have over electric and gas hobs is the rate at which an induction hob can heat a pot or other object placed thereon. In industrial applications, induction heated metal can go from cold metal to red hot in a matter of seconds.

Known induction hobs typically use a planar coil arrangement below a flat plate susceptor. Induction heating devices utilising such planar coils and flat plate susceptors, while enabling a liquid containing vessel to be supported on the heating device, comprise a very inefficient means of induction heating compared to other industrial applications of induction heating wherein a metallic object to be heated is placed inside a helical coil arrangement (usually referred to as a linear coil). However, the use of such a linear coil arrangement results in an elongate hollow structure that is not suited to the heating of water.

According to the present invention there is provided an induction heating device for heating a liquid, said device comprising a half ellipsoidal shaped induction coil and matching susceptor.

The susceptor may be arranged to be placed in thermal contact with a vessel for containing a liquid to be heated or may define at least part of a vessel for containing a liquid to be heated. Where the susceptor is exposed to the liquid to be heated it may be coated or covered by a protective layer, for example a thin plastic layer.

Preferably the susceptor is located within a vessel for containing a liquid to be heated such that the susceptor is in thermal contact with the liquid contained therein. The susceptor may be mounted within the vessel such that liquid contained in the vessel is in thermal contact with both the inner and outer faces of the susceptor. The susceptor may be spaced from an inner wall of the vessel by locating means, preferably in the form of a plurality of ribs or posts, preferably extending between an inner wall of the vessel and an outer wall of the susceptor. At least one aperture may be provided in a lower region of the susceptor to facilitate convection within the vessel.

In one embodiment, typically where the device is in the form of a kettle for heating or boiling water, the induction coil and susceptor may form part of and/or may be located within the vessel.

In an alternative embodiment, the vessel may be separate from the induction coil. For example, the induction coil may be mounted in a base upon which the vessel may be detachably located.

In one embodiment at least a lower region of the vessel may be shaped to sit in a bowl shaped recess defined in a body of the device, the induction coil being located beneath or within said bowl shaped recess. Preferably the susceptor is provided adjacent or within said lower region of the vessel.

In an alternative embodiment the device includes a dome shaped body, said induction coil being located beneath or within said dome shaped body, the vessel incorporating a recess for receiving said dome shaped body. A flux concentrator may be provided below the induction coil. The flux concentrator may be in the form of a ceramic shell. Preferably the susceptor is provided adjacent or within said recess of said vessel to be located over said dome shaped body.

To allow the device to be used to heat water contained in existing bottles or other receptacles, the vessel may be adapted to be coupled to the neck of an existing bottle or other liquid receptacle. Preferably the vessel includes a neck portion having coupling means for coupling the vessel to the neck of a bottle. In one embodiment the coupling means comprises a resilient seal to be received within or over the neck of a bottle. The resilient seal preferably comprises an annular body provided around a neck portion of the vessel, an outer face of the annular body being tapered towards an open end of the neck portion of the vessel to be insertable into the neck of the bottle. It is envisaged that the coupling means might comprise cooperating threaded portions provided on the respective necks of the vessel and the bottle.

The provision of a half ellipsoidal shaped induction coil and susceptor takes advantage of efficiency improvements inherent in a linear coil arrangement but also to increase the surface area of the susceptor which can be placed in contact with a liquid to be heated. This arrangement increases the surface area by 65% to that of a flat bottom pot of the same diameter when placed on a known planar induction hob.

In one embodiment the induction heater may be adapted to heat a liquid in a container, for example to define a kettle. The susceptor may be placed in thermal contact with a vessel arranged to hold a liquid to be heated or may be located within the vessel to be in contact with a liquid container therein. The induction coil and susceptor may be built into a vessel, such as a kettle, and arranged to define a bowl shaped region in the bottom of the vessel. Alternatively the induction coil and/or susceptor may be separable from the vessel, for example to be detachable from the vessel once the contents of the vessel have been heated. The vessel may be adapted to sit in a bowl shaped recess defined by the induction coil and/or susceptor. Alternatively the vessel may incorporate a recess for receiving a domed shaped body defining said induction coil and/or susceptor.

In an alternative embodiment the induction heater may be adapted to heat a liquid in a bottle, for example milk or infant formula an infant's bottle, or in vessel attachable to a neck of a bottle or other liquid receptacle. In one embodiment the induction coil may be inverted and mounted in a base, preferably in a domed portion of said base. A flux concentrator, which may be embodied in the form of a ceramic shell, may be provided below the coil. In an alternative embodiment the induction coil may be provided in a bowl shaped recess, the vessel having a dome shaped lower region incorporating said susceptor whereby the vessel may be received within said bowl shaped recess. The vessel may be adapted to be fitted to the neck of a bottle such that the bottle may be inverted to transfer any liquid therein into said vessel such that the liquid can be heated within the vessel before being returned to the bottle by inverting the vessel before removing the vessel from the bottle. The vessel may be in the form of a lid attachable to the bottle.

The use of an ellipsoidal coil and susceptor provides the benefits of a planar coil in terms of supporting a receptacle on the induction heater but greatly increases the surface area of the susceptor which can be placed in contact with a receptacle and/or be placed in thermal contact with a liquid to be heated.

The susceptor may be made from a highly permeable metal alloy, such as Radiometal 4550, EFI Alloy 50, EFI Alloy 79 or HyMu 80, to further increase the efficiency of the heating device. It is also envisaged that other materials may be used, such as graphite, molybdenum, silicon carbide, or graphene or other nano-metals.

Permeability is a ratio of the magnetic induction output to the magnetic field strength input that produced the induction. The higher the permeability, the better the magnetic performance.

According to a further aspect of the present invention there is provided a method of controlling an electronic device, in particular an induction heating device for heating a liquid in a vessel, comprising providing a base within which the vessel to be heated is received within or upon a seat thereof, providing a marking on a surface of the vessel, providing a sensor on the base responsive to said marking, the method comprising providing a control input to the electronic device by moving or otherwise manipulating the vessel with respect to the base such that the position of the marking with respect to the sensor is varied.

Preferably said marking is provided with a variable thickness along a length thereof, said vessel being manipulated such that the portion of the marking exposed to the sensor is adjusted to provide said control input to the electronic device. Preferably said movement or manipulation of the vessel comprises rotation of the vessel with respect to the base, preferably about an axis of rotational symmetry of the vessel.

According to a further aspect of the present invention there is provided an electronic device having a first part moveable with respect to a second part, said first part having a marking thereon and said second part having a sensor for detecting a property of said marking, whereby a control input is provided to the device by moving the second part with respect to the first part such that the property of said marking detected by the sensor is varied. In one embodiment said marking comprises an elongate marking having a variable thickness along the length thereof, said sensor being adapted to detect the width of the marking at the position of the sensor. Preferably said second part is rotatable with respect to said first part, preferably about an axis of rotational symmetry of the second part. Preferably the electronic device comprises an induction heating device, said first part comprising a base and said second part comprising a vessel within which a liquid can be heated, said vessel being received within or upon a seat provided on the base. In one embodiment the sensor comprises an Infrared transceiver. Alternatively the sensor may comprise an optical sensor.

According to a further aspect of the present invention there is provided a heating apparatus for heating a liquid in a vessel, said apparatus including heating means for heating liquid with said vessel, means for determining the weight of the vessel to determine the amount of liquid within the vessel and control means for controlling the heating means in response to the output of the weight determining means.

Preferably the heating means comprises an induction heating means. Preferably the vessel incorporates a susceptor, said apparatus including a base upon which the vessel is supported, said base incorporating an induction coil for generating heat in the susceptor. Preferably the induction coil and susceptor have a half-ellipsoidal shape.

Said weight determining means may comprise a load cell adapted to support the vessel during heating of the liquid therein.

Embodiments of the present invention will now be described, by way of example only, with reference to the accompanying drawings, in which:

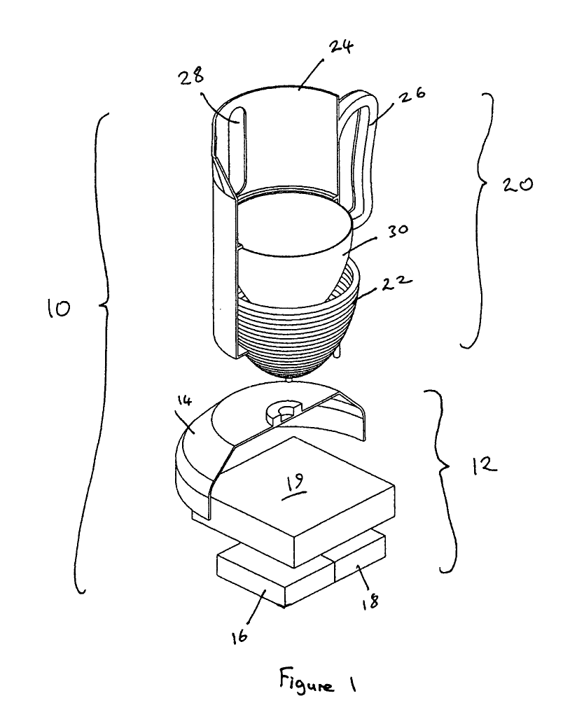

FIG. 1 is a part sectional exploded view of an induction heating device in accordance with a first embodiment of the present invention in the form of a kettle;

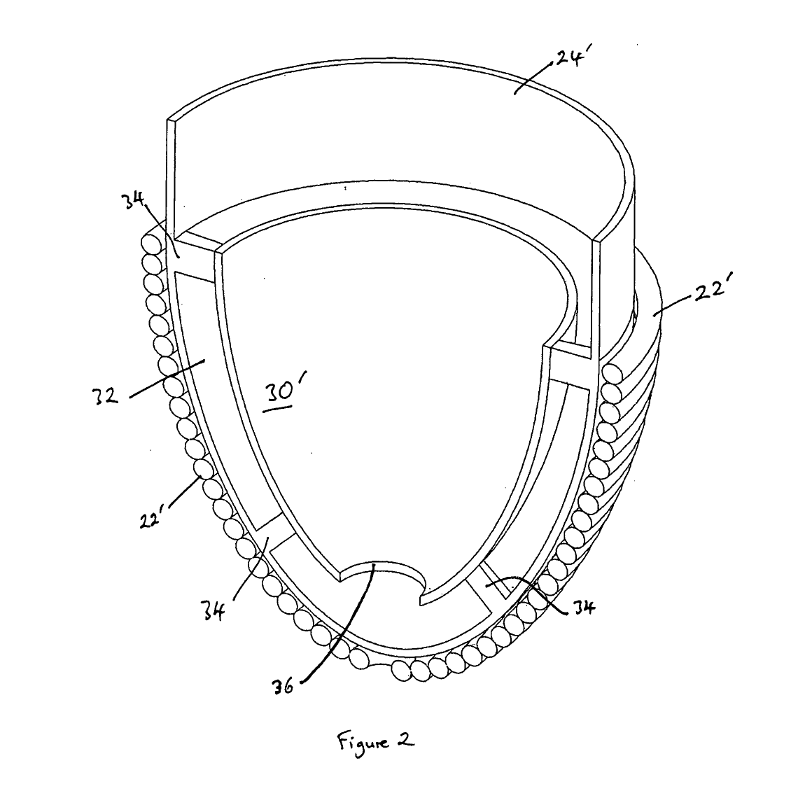

FIG. 2 is a sectional view through the lower portion of an induction heating device in accordance with a modified embodiment of the invention;

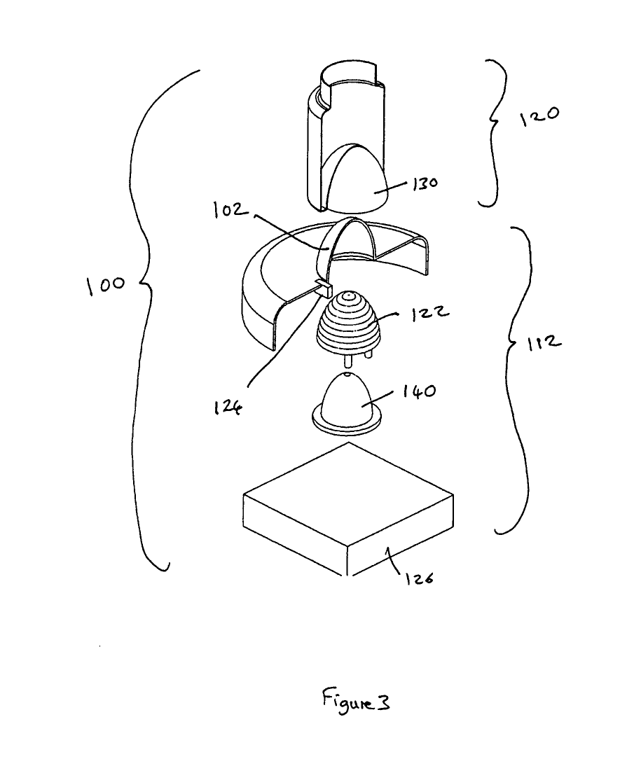

FIG. 3 a part sectional exploded view of an induction heating device in accordance with a further embodiment of the present invention in the form of a bottle warmer for heating infant formula in a bottle;

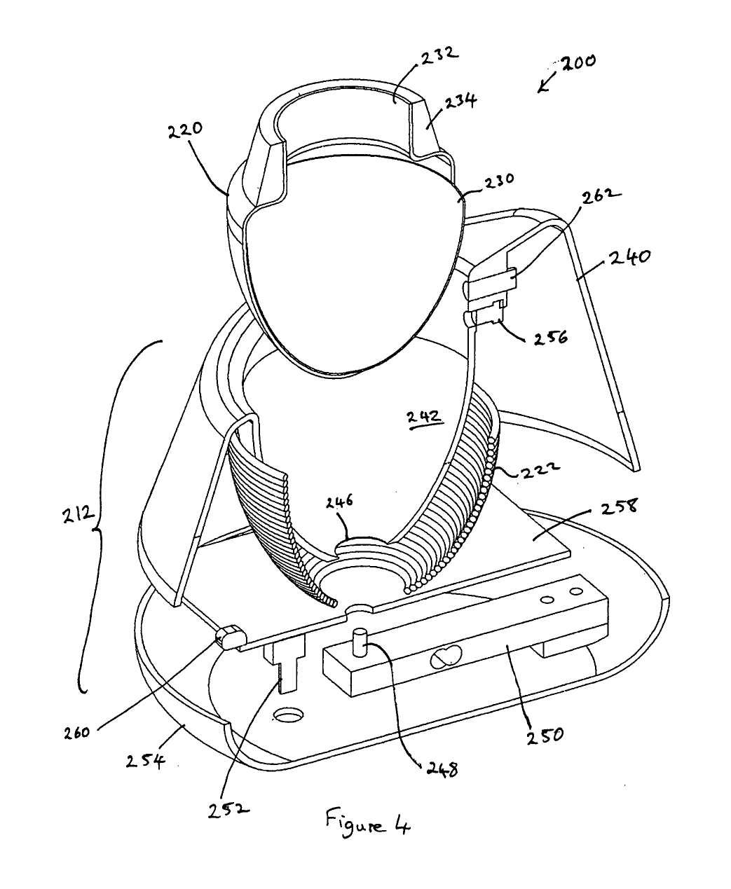

FIG. 4 is a sectional exploded view of an induction heating device in accordance with a fourth embodiment of the present invention for heating infant formula in a vessel adapted to be coupled to a bottle;

FIG. 5 is a part sectional view of the vessel of FIG. 4 fitted to a bottle;

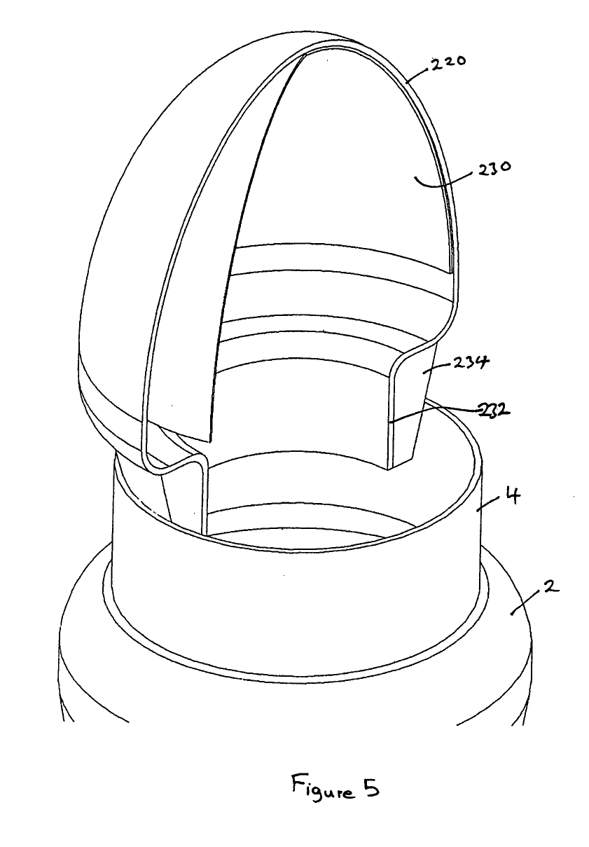

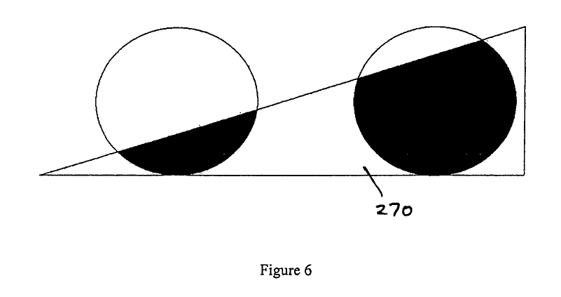

FIG. 6 is a schematic view of a marking which may be applied to the vessel of the device of FIG. 4 to facilitate control of the device; and

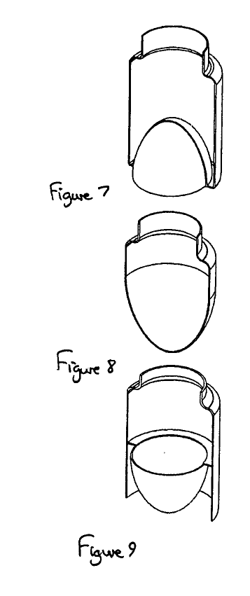

FIGS. 7 to 9 illustrate different ways in which a susceptor may be incorporated into a vessel in an induction heating device in accordance with the present invention.

As shown in FIG. 1, an induction heating device in accordance with a first embodiment of the present invention comprises a kettle for boiling water. The device 10 comprises a base 12 providing a power supply for the heating device. The base 12 comprises a housing 14 containing a heat sink 16, fan 18 and inverter 19, electrical contacts being provided on an upper part of the base 14 for supplying electrical power to an induction coil 22 built into an upper part 20 of the device 10.

The upper part 20 of the device 10 comprises a housing 24 defining a water carrying vessel having a carrying handle 26 and a window 28 for indicating the level of water in the housing. A lower part of the vessel is defined by or incorporates a half-ellipsoidal susceptor 30 formed from a ferromagnetic material, preferably a high permeability metal alloy, such as Radiometal 4550, EFI Alloy 50, EFI Alloy 79 or HyMu 80 having a high ratio of magnetic induction output to magnetic field strength input (μ). Such materials provide better magnetic performance and thus greater heating efficiency and also provide enhanced Hysteresis effects, further increasing efficiency.

A half-ellipsoidal induction coil 22 is mounted below the susceptor 30 such that the susceptor 30 is exposed to an electromagnet field generated by the coil 22 when the coil 22 is energised to heat the susceptor 30.

The half-ellipsoidal coil 22 and matching susceptor 30 provides a 65% increase in the surface area of the susceptor that can be used to heat water compared to a planar coil and susceptor. Thus the use of a half-ellipsoidal coil 22 and matching susceptor 30 provide a kettle having greater efficiency and faster heating that known electric kettles.

FIG. 2 illustrates a modified embodiment, wherein the susceptor 30′ is placed inside the vessel 24, preferably mounted in the base of an ellipsoidal lower portion of the vessel 24′. The induction coil 22′ is provided around such lower portion of the vessel. The susceptor 30′ is spaced from the inner wall 32 of the vessel and supported by ribs or posts 34 so that the liquid contained therein is in contact with both the inner and outer surfaces of the susceptor 30′, effectively doubling the thermal transfer area. An aperture 36 is provided in a lower region of the susceptor 30′ to aid convection within the vessel.

An induction heating device 100 in accordance with a third embodiment, illustrated in FIG. 3, defines a bottle warmer for heating infant formula/milk in a feeding bottle.

In such embodiment, a half-ellipsoidal induction coil 122 is mounted in a corresponding shaped upper part 102 of a base 112 of the device 100. A cooperating feeding bottle 120 is provided with a recessed base shaped to be received over the dome shaped upper part 102 of the base 112 such that the bottle 120 can sit on the base 112.

A half-ellipsoidal susceptor 130, similar to that of the heating device of FIG. 1, is provided in, or moulded into, the base of the bottle 120 to cooperate with the induction coil 122 such that the susceptor 130 matches and sits over the induction coil 122 when the bottle 120 is mounted on the base 112.

The induction heating device 100 of the third embodiment is effectively an inverted version of that of the first and second embodiments, with the addition of a flux concentrator 140 mounted in the base 112 below the induction coil 122. The means in which the infant formula is warmed is by heat conduction from the susceptor 130 provided in the base of the bottle 120 heated through induction heating.

As described above, the dome shaped upper part 102 of the base 112 incorporates a half ellipsoid induction coil 122 therein. The co-operating infant feeding bottle 120 is provided with a lower cavity arranged to receive the dome shaped upper part 102 of the base 112. The feeding bottle 120 incorporates a half ellipsoidal hollow shell susceptor 130 made from a ferrous metal, preferably a high n alloy, moulded or mounted into the cavity defined in its base. The bottle is shaped to sit onto the dome shaped upper part 102 of the base 112. When in this position the bottom of the bottle 120 will be in contact with a temperature sensor 124 provided on the base 112 whereby the temperature of the bottle 120 can be measured.

The device 100 may incorporate a controller which may be programmed to select a predetermined run cycle to achieve the desired temperature of the formula in the bottle which may be entered by the user via suitable controls.

This temperature may be achieved by heating the ferrous metal ellipsoid shape susceptor 130 built into the bottle 120 through the non-contact heating of electromagnetic induction. The susceptor may be provided with a protective coating, such as a layer of plastic, to prevent direct contact between the liquid to be heated and the surface of the susceptor. Alternatively the susceptor may be formed from stainless steel.

The fastest and most popular baby bottle warmer on the market is the Philips AVENT iQ Bottle Warmer which takes up to 5 minutes to heat 250 ml of chilled milk or formula to 37° C. Using the induction heating device in accordance with this embodiment of the present invention, the formula can be warmed to 37° C. in 30 to 60 seconds.

The benefits of this way of heating a babies bottle is that it bypasses the fundamental problem with conventional bottle warmers that heat from the outside in, having to penetrate the thick insulated wall of the bottle to heat the formula inside. This heating only begins after the water or steam that the bottle warmer uses has become hot enough.

The difference between the induction heating device 100 of the third embodiment and that of the first and second embodiments is that the use of the coil/susceptor arrangement is inverted. What this means to the design and operation of the device is that the susceptor is on the outside of the coil. The inside of the coil is where the magnetic field is strongest but this problem is rectified by providing a ceramic flux concentrator 140 in the base 112 within the coil 122 to reflect the magnetic field back out where it will be absorbed by the susceptor 130 on the outside of the coil and heat it. Also the baby bottle warmer will not require a heat sink and fan to cool the electronics 126 in the base because the operation cycle time is so short that the electronics 126 wont have time to overheat, which is very unique to this type of electronics.

The induction heating device in accordance with the third embodiment of the present invention may aid night feeding and reduce the time the baby is distressed waiting to be fed thus making it easier for the baby to settle back to sleep and less time awake benefiting the child and the parent.

The unit can sit by the cot and while the bottle takes 30 to 60 seconds to warm the parent can comfort the baby. The dimensions of the infants bottle and susceptor may be in proportion to each other that when the bottle is filled with the minimum amount of milk/formula an infant consumes (typically 80 ml) the susceptor will be completely submerged in the liquid.

An induction heating device 200 in accordance with a fourth embodiment of the present invention is illustrated in FIGS. 4 and 5. In such embodiment, the vessel 220 in which the liquid, in this case infant formula/milk (which may comprise breast milk), is heated comprises a hollow body having an ellipsoidal base within which is mounted a half ellipsoidal susceptor 230, similar to that of mounted in the bottle of the third embodiment, the vessel 220 having an open neck 232 adapted to be coupled to an infant's feeding bottle 2 (see FIG. 5). The vessel 220 thus effectively defines a lid for the feeding bottle.

It is envisaged that the neck 232 of the vessel 220 may be threaded to engage a threaded neck of a feeding bottle such that the vessel can be fitted to the bottle in the manner of a lid. In the embodiment shown in FIGS. 4 and 5, the neck 232 of the vessel 220 is provided with a tapered resilient annular seal 234 fitted around the neck 232 of the vessel 220, preferably formed from food grade rubber, such that the vessel 220 can be pushed into the neck 4 of a feeding bottle 2 with the neck 232 of the vessel 220 received inside the neck 4 of the feeding bottle, the tapered seal 234 engaging the inner sides of the neck 4 of the feeding bottle 2 to form a watertight seal between the vessel 220 and the feeding bottle 2, as shown in FIG. 5. The tapered shape of the seal 234 enables the vessel 220 to be fitted to feeding bottles having necks of differing diameter, rendering the device suitable for use with a number of different existing feeding bottles.

As shown in FIG. 4, an upper part 240 of the base 212 of the device comprises an elliptically shaped recessed portion 242 into which the correspondingly shaped base of the vessel 220 can be inserted such that the vessel 220 can be supported on the base 212 within the recessed portion 242 of the base 212. An elliptical induction coil 222 is mounted in upper part 240 the base 212, below the recessed portion 242, such that the susceptor 230 of the vessel 220 is located within and in close proximity to the coil 222 when the vessel 220 is mounted in the recessed portion 242 of the base 212.

An aperture 246 is provided in the bottom of the recessed portion 242 of the base 212, through which a projection 248 attached to a load cell 250 extends to engage the vessel 220 when the vessel 220 is in the recessed portion 242 of the base 212, such that the load cell 250 can provide an indication of the weight of the vessel 220 and its contents. A calibration button 252, accessible through a hole in the bottom part 254 of the base 212, is provided for calibrating the load cell 250 to the weight of an empty vessel 220 to enable an accurate determination of the weight, and hence amount, of formula/milk contained in the vessel.

A temperature sensor 256, preferably in the form of an infrared sensor, is mounted in a side of the recessed portion 242 of the base 212 whereby the temperature of the vessel 212, and its contents, can be determined.

A controller 258 is provided for controlling the operation of the device. The controller 258 may receive signals from the load cell 250 and temperature sensor 256 to allow the controller to determine the amount of milk/formula present in the vessel 220 and to determine the initial temperature of the milk/formula and thus the amount of heating required and/or to determine when a target temperature has been reached.

In use, the vessel 220 can be attached to a bottle 2 containing a measure of infant formula or breast milk and the bottle 2 can be inverted to transfer the formula into the vessel 220. Alternatively a desired volume of milk/formula may be placed directly into the vessel 220. The vessel 220 is then placed into the recessed portion 242 of the base 212 of the device 200 and the controller 258 determines the volume of milk/formula present and energises the induction coil 222 for a pre-programmed interval to achieve a desired temperature for the given amount of formula in the vessel. An LED 260 or sounder may be provided on the device to indicating when the device is operating and/or when a heating cycle has completed. The controller 258 may contain a timer for controlling the duration of operation of the device 200 and/or for controlling the initiation of such operation, for example at a preselected time.

Once the heating cycle has completed, the vessel 220 may be removed from the base 212 and inverted, after reattaching the vessel 220 to the feeding bottle 2 if it is not already attached thereto, to pass the heated milk/formula into the bottle.

The base 212 may be formed from a translucent material and may be illuminated by illumination means, preferably by one or more LEDs, to indicate when the device is operating and/or when a heating cycle has been completed. The device may also serve as a night light when the unit is not being used for heating formula by activating said illumination means.

A light sensor or infrared transceiver 262 may be provided in a side of the recessed portion of the base and the vessel may be provided with markings or other recognisable indications whereby the target temperature, heating time or other aspects of the operation of the device may be controlled by rotating the vessel within the recessed portion of the base. Such markings may comprise a tapered black line 270, as shown in FIG. 6, extending around a circumferential portion of the vessel such that the width of the black line at the sensor may be determined as a control input to the controller, such width varying as the vessel 220 is rotated with respect to the base 212. This may avoid the need for external buttons or other controls on the device.

FIGS. 7 to 9 illustrate different ways in which a half ellipsoidal susceptor may be incorporated into a vessel in an induction heating device in accordance with the present invention.

While the present invention has been described in relation to its use in a water heating kettle and a bottle warmer it is envisaged that the induction heating device incorporating a half-ellipsoidal coil and matching susceptor in accordance with the present invention may be incorporated in many other heating devices in numerous other applications, for example in relation to induction hobs, water heaters, boilers, deep fat fryers, immersion heaters, catering urns, wax melting pots, freeze protection systems, process systems, heat transfer systems and other fluid heaters.

The invention is not limited to the embodiment(s) described herein but can be amended or modified without departing from the scope of the present invention.

1. An induction heating device for heating a liquid, said device comprising a half ellipsoidal shaped induction coil and matching susceptor,

2. The device as claimed in claim 1, wherein the susceptor is arranged to be placed in thermal contact with a vessel for containing a liquid to be heated,

3. The device as claimed in claim 1, wherein the susceptor defines at least part of a vessel for containing a liquid to be heated.

4. The device as claimed in claim 1, wherein the susceptor is located within a vessel for containing a liquid to be heated such that the susceptor is in thermal contact with the liquid contained therein.

5. The device as claimed in claim 4, wherein the susceptor is mounted within the vessel such that liquid contained in the vessel is in thermal contact with both the inner and outer faces of the susceptor.

6. The device as claimed in claim 5, wherein the susceptor is spaced from an inner wall of the vessel by locating means.

7. The device as claimed in claim 6, wherein said locating means comprise a plurality of ribs or posts.

8. The device as claimed in claim 5, wherein at least one aperture is provided in a lower region of the susceptor to facilitate convection within the vessel.

9. The device as claimed in claim 3, wherein the induction coil and susceptor form part of and/or are located, within the vessel.

10. The device as claimed in claim 2, wherein at least a lower region of the vessel is shaped to sit in a bowl shaped recess defined in a body of the device, the induction coil being located beneath or within said bowl shaped recess.

11. The device as claimed in claim 10, wherein the susceptor is provided adjacent or within said lower region of the vessel.

12. The device as claimed in claim 2, wherein the device includes a dome shaped body said induction coil being located beneath or within said, dome shaped body, the vessel incorporating a recess for receiving said dome shaped body.

13. The device as claimed in claim 12, wherein a flux concentrator is provided, below the induction coil.

14. The device as claimed in claim 13, wherein said flux concentrator is in the form of a ceramic shell.

15. The device as claimed in claim 12, wherein the susceptor is provided adjacent or within said, recess of said vessel to be located over said dome shaped body.

16. The device as claimed in claim 10, wherein further comprising means for determining the weight of the vessel to determine the amount of liquid within the vessel and control means for controlling the operation of the device in response to the output of the weight determining means.

17. The device as claimed in claim 16, wherein said weight determining means comprises a load cell adapted to support the vessel during heating of the liquid therein.

18. The device as claimed in claim 17, wherein further comprising a temperature sensor for determining the temperature of liquid in said vessel, said control means utilising information from the temperature sensor when controlling the operation of the device.

19. The device a claimed in claim 18, wherein said control means is programmed to control the operation of the device as a function of the initial temperature of the liquid, in the vessel as determined by the temperature sensor and the amount of liquid within the vessel as determined by the weight determining means.

20. The device as claimed in claim 2, wherein the vessel is adapted to be coupled to the neck of a bottle or other liquid receptacle.

21. The device as claimed in claim 20, wherein the vessel includes a neck portion having coupling means for coupling the vessel to the neck of a bottle.

22. The device as claimed in claim 21, wherein said coupling means comprises a resilient seal to be received within or over the neck of a bottle.

23. The device as claimed in claim 22, wherein said resilient seal comprises an annular body provided around a neck portion of the vessel, an outer face of the annular body being tapered towards an open end of the neck portion of the vessel to be insertable into the neck of the bottle.

24. (canceled)
